(19) United States
(12) Patent Application Publication
(10) Pub. No.: US 2005/0177288 A1
(43) Pub. Date: Aug. 11, 2005

(54) Interdependent control of aftermarket vehicle accessories without invasive control connections

(76) Inventors: James D. Sullivan, Galena, OH (US); John A. Melvin, Westerville, OH (US); Charles E. Bennett, Westerville, OH (US)

Correspondence Address: KREMBLAS, FOSTER, PHILLIPS & POLLICK, 7632 SLATE RIDGE BOULEVARD, REYNOLDSBURG, OH, 43068, US

(21) Appl. No.: 10/882,156

(22) Filed: Jul. 1, 2004

Related U.S. Application Data
(60) Provisional application No. 60/542,020.
(60) Provisional application No. 60/542,772, filed on Feb. 6, 2004.

(51) Int. Cl. G06F 19/00

(52) U.S. Cl. 701/36; 307/10.1

(57) ABSTRACT

An interdependent control apparatus for an accessory mounted to a vehicle. An accessory control connector is connected to the vehicle's on board diagnostic port data bus and an accessory microcontroller is in data communication with the accessory control connector. An output device associated with and operating a component of the accessory is in data communication with the accessory microcontroller for control of an accessory parameter. Parameters of a vehicle are also controlled by the accessory microcontroller. Data from the accessory is also input to the accessory microcontroller representing a parameter of the accessory. Data is input from both the data bus and the vehicle accessory to the accessory microcontroller. Output control data from the accessory microcontroller can control a vehicle parameter and most importantly controls an accessory parameter. This is particularly useful for safety interlocks to stop the engine operation in response to a potentially hazardous event, such as a change in one or more of the vehicle input parameters.

### CROSS-REFERENCES TO RELATED APPLICATIONS This application claims the benefit of U.S. Provisional Applications Nos. 60/542,020 filed Feb. 5, 2004 and 60/542,772 filed Feb. 6, 2004.

### STATEMENT REGARDING FEDERALLY-SPONSORED RESEARCH AND DEVELOPMENT

(Not Applicable)

### REFERENCE TO AN APPENDIX

(Not Applicable)

### BACKGROUND OF THE INVENTION

1. Field of the Invention

This invention relates generally to accessories mounted to motorized vehicles and more particularly relates to the control of some of the parameters of the accessory or the vehicle or both in which the control is interdependent, that is control of one is a function of parameters of the other or both.

2. Description of the Related Art

Standard, motorized production vehicles, such as automobiles and light and heavy duty trucks, are equipped with a variety of accessories by their original manufacturers. However, many accessories do not enjoy a market of sufficient volume to justify their being included as original equipment on any line of standard, mass production vehicles. Consequently, there are many accessories which are either custom installed for the purchaser of the vehicle or are installed by special equipment manufacturers who purchase standard production vehicles from a vehicle manufacturer, install the special accessory and then resell the equipped vehicles in a chain of distribution leading to the ultimate users. There is a large diversity of such aftermarket accessories and undoubtedly will be additional ones in the future. They include both implements and tools as well and conveniences and luxuries. A few examples include motorized wheel chair lifts and ramps, cranes for loading and unloading payloads from trucks, hydraulic or compressed air systems for operating tools, emergency medical or other equipment on emergency vehicles, remote vehicle operating parameter monitors, such as a remote rpm indicators, remote controls, safety interlocks for other accessories, and many more.

Both vehicles and accessories have operating conditions and states which can be automatically monitored by sensors and detectors to provide values of measured parameters indicative of their operating conditions and states. Many vehicle mounted accessories require or benefit from control which is interdependent with the vehicle. Interdependent control means control of the accessory as a function of one or more vehicle parameters and one or more accessory parameters, control of the vehicle in part as a function of one or more parameters of an accessory, or control of both as a function of parameters of both. For example, safety is an important characteristic. Many accessories should not be operated or should have their operation limited unless the vehicle is in a safe state, such as in a state of no motion, the parking brake engaged and the transmission in park. It can also be desirable to stop engine operation if the accessory is being utilized and some particular vehicle parameter changes to a particular state, such as a change in any of the above states.

For accessories which utilize electrical power supplied by the vehicle storage battery, it is often desirable that the engine be operated at some minimum engine speed or rpm in order to supply sufficient power to the accessory and avoid discharging the battery. Alternatively, it may be desirable to increase engine speed when an accessory parameter, such as electrical power consumption, exceeds some selected value and may even be desirable to increase engine speed as a function of the accessory power consumption or other parameter.

Some vehicles are provided with a power take off (PTO) to which components of accessories are attached to provide a mechanical drive for the accessory. For example, a PTO may drive a hydraulic pump for operating hydraulic motors which drive an accessory such as a crane boom, an air pump for an air compressor, or a large electrical generator for a welder. Interdependent control is often needed for these kinds of accessories. For example, when a crane boom is operated under increased load, it may be necessary to increase the engine rpm to provide sufficient power to the hydraulic motor. A similar need exists for driving a welder under load. Additionally, these accessories also require safety features, such as assuring that the vehicle's transmission is not engaged during crane operation and that the parking brake remains engaged.

In the prior art, a problem with accomplishing interdependent control of the vehicle and the accessory is that it has required the somewhat destructive intervention into the vehicle component parts in order to install or connect additional components. Such additional components include sensors which provide signals to the accessory control system and output devices, such as switches or motors, which are controlled by the accessory control system and affect vehicle parameters and operation. This installation usually minimally includes making additional electrical connections to original vehicle electrical equipment. The installation of these additional parts not only requires extensive time and labor, which is a substantial cost, but can also compromise vehicle integrity and reliability, especially if protective sealing materials must be destroyed or existing wiring is damaged while making a connection. The prior art has required separate, additional, hardwired paths for each of the desired input data parameters and for each output device which controls the vehicle parameters and accessory parameters. The number of connections are often numerous and consequently the opportunity for damage and the added cost of making these connections are large.

For example, where the prior art has sought to control engine rpm, one solution has been to connect a cable or vacuum actuator to the accelerator pedal or its mechanical linkage. An approach for the more recent accelerator systems, that use a potentiometer operated by the accelerator pedal, is to break the electrical connection and electrically interpose circuitry in the original electrical connection to that potentiometer. The interposed circuitry has a state to allow normal operation of the accelerator pedal for driving and a state for accessory control which simulates the potentiometer. Such a connected mechanical, electromechanical or electrical device is controlled by an accessory control system. In addition, an accessory control system which controls engine rpm for proper accessory operation, must also be able to sense the engine rpm. This is done in the prior art by either installing a separate sensor or by making an additional electrical connection to a factory installed engine speed sensor.

Where safety features are included in a prior art accessory control system, analogous additional physical connections must be made to the parking brake or its sensing switch and to the transmission status detecting switches. The greater the number of parameters which must be sensed or controlled, the greater is the number of expensive and potentially damaging invasive interventions that are required.

One specific example of the invasive connection problem is the installation of wheel chair lifts and ramps on vehicles. Recently, the federal government has mandated a specific set of safety specifications defining the proper and safe operation of wheelchair lifts and ramps (FMVSS 403 and FMVSS 404). Proper and safe operation has become more important because of the common practice of leaving the engine running to provide power and air conditioning while the wheelchair lift or ramp is deployed and recovered. Chief among the safety requirements is that the vehicle be placed in a “safe condition” before deployment of a wheelchair lift or ramp. A safe condition is when the vehicle's parking brake is set and the vehicle's transmission is in park. During deployment and recovery, the vehicle must not be placed in an unsafe condition, such as by releasing the parking brake, moving the shift mechanism out of the park position, etc.

There are currently several products and several techniques available to provide a vehicle lift or ramp safety interlock. Among the most common are devices that monitor the parking brake and gearshift position to provide a signal to the wheelchair lift or ramp when the wheelchair lift or ramp can be operated. All of these devices currently suffer from the problem that they must be wired to various components of the vehicle's existing electrical system. This requires invasive modification of the vehicle's electrical system, possibly compromising performance and safety, in addition to warranty coverage, of the vehicle. One example of a system of this type is described in U.S. Pat. No. 6,594,565. Additionally, there are so many variations between vehicle makes, models and years that an enormous number of possible modifications to the electrical system arise, thereby making a faulty installation more probable.

Although a power supply connection to the vehicle electrical power system, such as directly to the battery cable or terminal, is always required for an accessory which uses vehicle electrical power, it is an object and feature of the present invention to eliminate the need for many, and in most cases all, of the discrete, invasive connections to diverse components of the vehicle in order to provide sensed or other input data and output control actions and yet still provide control which is interdependent between the accessory and the vehicle.

As will be seen below, the invention uses the conventional on board diagnostic port connector which is standard on vehicles manufactured or sold in the U.S. since 1996 or it uses the data bus to which the diagnostic port connector is connected. This diagnostic port connector is usually located immediately below the dashboard within a foot or so of the steering column. This connector is also known as the data port connector and the data link connector (DLC). Current connectors use the on board diagnostics OBD II standards and protocol and this connector will be referred to as the OBD II connector or simply the OBD connector.

The OBD connector provides a data bus for communicating a large number of vehicle parameters. Such on board diagnostic data port connectors were created to allow diagnosis of engine operation in order to reduce pollutant emissions. They became possible because, as pollution standards became more strict, vehicle manufacturers turned to on board computers to control engine operation. These computers required both input devices for sensing vehicle operational parameters and output devices and systems which the computers controlled and which control or affect vehicle parameters. Current on board computers for vehicles typically have multiple computer modules in data intercommunication, principally the engine control module (ECM) [sometimes referred to as the engine control unit (ECU)] which controls spark timing, fuel delivery and emission controls, a transmission control module and one or more other modules for the remainder of the vehicle. The ECM receives signals from an extensive array of sensors and input devices on or near the engine and sends control signals to the valves, controllers and other output devices. It also stores diagnostic trouble codes which are used to warn drivers of service needs and for diagnostic analysis by service mechanics. The other modules likewise receive data from sensors and can communicate them to other modules. However, for purposes of the invention, these computer modules can be referred to collectively as the vehicle computer or computer system.

The input data collected by the vehicle's computer system was made available at the OBD connector through a data bus. That data came to be used not only to detect vehicle emission problems, but also to be used by vehicle repair mechanics to detect other types of vehicle malfunction causes. The data port of the OBD connector also became bidirectional because some emission tests required parameter changes as a part of the test, for example operation first at a lower engine rpm and then at a higher engine rpm. Since the modern OBD connector is connected to the on board vehicle computer and that computer both receives an extensive array of data and controls so much of the vehicle, the OBD connector allows an external device to both receive vehicle data and also to transmit command data to the on board computer to affect vehicle operation. This is accomplished with the use of one of three principal OBD II data communication protocols which different manufacturers have adopted and descriptions of these protocols are publicly available.

The prior art has used this connector for diagnostic purposes and for recording data for later diagnostic analysis. The principal use is the application of signals from the OBD II connector to a variety a scan tools which are connected to it. These scan tools are usually computer based read out equipment and come in a variety of costs and sophistication. Some merely provide codes or data while others have software to analyze performance and detect problems. The data has been analyzed to determine performance of the vehicle, particularly the engine, and also to analyze the performance or driving activities of the driver.

One prior art device sold by Davis Automotive Products is a data logger which plugs into the OBD II connector and records data as the vehicle is driven. That data is then downloaded to a personal computer which analyzes and displays the data.

Another device also sold by Davis connects to the OBD II connector and has an on board LCD display mounted to its connector and is located in use next to the steering wheel so the driver can view time, distance, top speed, and average speed. It also has audible alarms which sound when user-settable limits for speed, acceleration and deceleration are exceeded in order to give feedback to drivers.

However, it is an object and feature of the invention to use the OBD connector or its data bus in association with a subsequently installed aftermarket accessory to allow interdependent control based upon use of one or more accessory parameters with one or more vehicle operational parameters. This allows logic or software external to the production vehicle to control-both the accessory and some vehicle parameters based upon the needs of the accessory and its operation.

It is a particular object and feature of the invention to provide an interdependent control which is capable of providing one or more output signals to an accessory output device or to a vehicle computer as a function of one or more vehicle parameters and/or one or more accessory parameters.

Another object and feature of the invention is to provide an interdependent control which is capable of stopping engine operation upon the occurrence of a potentially unsafe or hazardous event by detecting the event as a function of both one or more vehicle parameters and one or more accessory parameters.

### BRIEF SUMMARY OF THE INVENTION

The invention is a control apparatus for an accessory mounted to a vehicle, the vehicle having an on board diagnostic port connector connected through a data bus to the vehicle's on board engine control computer. The invention has an accessory control connector for connecting to the vehicle's on board diagnostic port data bus and an accessory microcontroller physically mounted to and transportable with the vehicle and connected through a data communication path with the accessory control connector. At least one device is associated with and connected through a data communication path with the accessory microcontroller. The device is either one or both of (i) an accessory input device for sensing an accessory parameter and transmitting the sensed parameter data to the microcontroller and (ii) an accessory output device operating a component of the accessory for control of an accessory parameter by the microcontroller. The invention also may have a variety of accessory inputs to the accessory microcontroller. One such input is a continuously variable input to the accessory microcontroller for controlling the speed of an engine of the vehicle.

The invention also contemplates a method for controlling parameters of a vehicle having an accessory mounted to the vehicle, the vehicle having a vehicle computer connected to an on board diagnostic port connector through a data bus. The accessory has at least one data input device for supplying data to the accessory microcontroller representing a parameter of the accessory. The method comprises attaching an accessory control connector to the data bus, inputting data from both the data bus and the vehicle accessory to the accessory microcontroller and outputting a control signal from the accessory microcontroller in accordance with a microcontroller control algorithm. The output control signal can control a vehicle parameter and or an accessory parameter or both. The data input from the diagnostic port data bus can include one or more input vehicle parameters including parking brake status, a gear shift control status, engine rpm, clutch status and service brake status. These are particularly useful for safety interlocks. One or more of these together with one or more input parameters from the accessory can be used, for example, to stop the engine operation in response to a potentially hazardous event, such as a change in one or more of the vehicle input parameters.

### BRIEF DESCRIPTION OF THE SEVERAL VIEWS OF THE DRAWINGS

FIG. 1 is a block diagram illustrating the invention.

FIG. 2 is a block diagram of the preferred embodiment as applied to a wheel chair lift but useful for other applications.

FIG. 3 is a block diagram of an alternative embodiment of the invention.

In describing the preferred embodiment of the invention which is illustrated in the drawings, specific terminology will be resorted to for the sake of clarity. However, it is not intended that the invention be limited to the specific term so selected and it is to be understood that each specific term includes all technical equivalents which operate in a similar manner to accomplish a similar purpose. For example, the word connected or term similar thereto are often used. They are not limited to direct connection, but include connection through other circuit elements where such connection is recognized as being equivalent by those skilled in the art. In addition, many circuits are illustrated which are of a type which perform well known operations on electronic signals. Those skilled in the art will recognize that there are many, and in the future may be additional, alternative circuits which are recognized as equivalent because they provide the same operations on the signals.

### DETAILED DESCRIPTION OF THE INVENTION

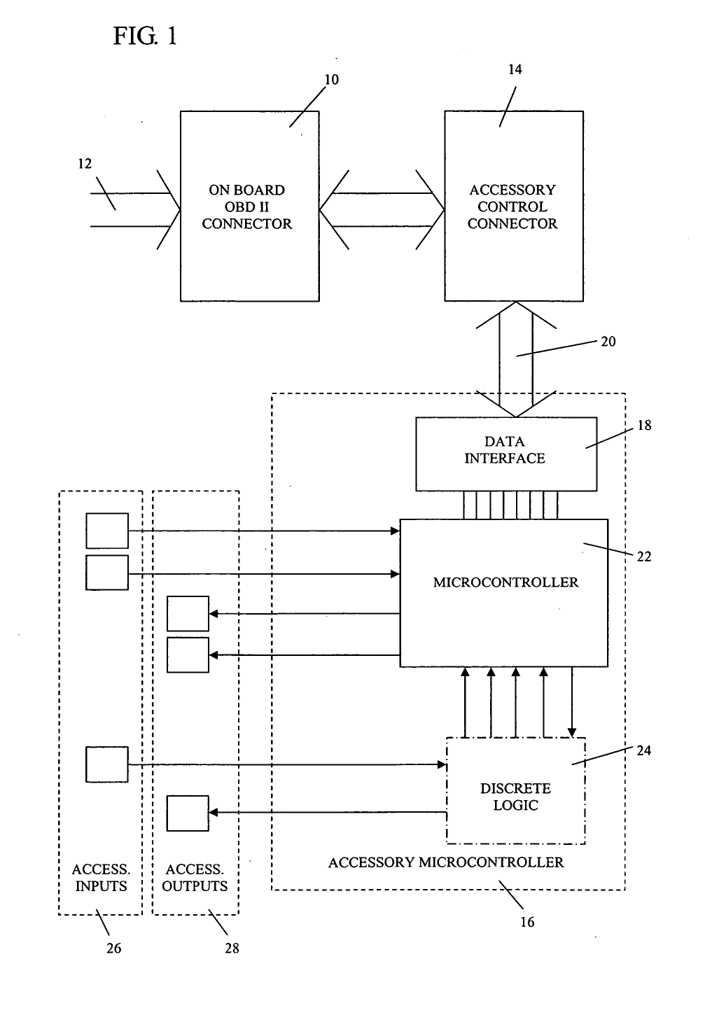

Referring to FIG. 1, production vehicles are manufactured with a standard OBD II connector 10 connected to the vehicle's on board computer or engine control module through a data bus 12. A mating accessory control connector 14 electrically connects to the OBD connector 10 thereby connecting the data bus 12 to an accessory microcontroller 16. The accessory control connector 14 may be electrically connected to the vehicle's data bus 12 by physically engaging the ODB II connector or it may be connected to another connector which carries that bus.

The accessory microcontroller 16 is the circuitry that performs the logic functions which are performed because of the addition of the accessory to the vehicle and performs the logic according to a control algorithm. The accessory microcontroller 16 can be a conventional or commercially available microcontroller, that is a special purpose computer for controlling equipment and having a data processor, data storage and input and output connections. Such a microcontroller performs the logic functions with stored software as is well known in the art. Alternatively, the accessory microcontroller 16 can be a programmable logic device (PLD) or a combination of a conventional microcontroller, and a PLD or some additional discrete logic circuitry, such as AND, OR, NOR and NAND gates that, together with the conventional microcontroller, perform the logic functions with those logic functions being distributed between the hardwired, logic circuits and the commercial microcontroller. A microcontroller based control system would ordinarily also include the usual interfaces or buffers and other conventionally known computer circuitry. Because the logic or data processing functions can be performed by a conventional microcontroller or other known logic devices or by a combination of them with the logic functions distributed between them, the term “accessory microcontroller” or “microcontroller” alone is used, unless otherwise indicated, to include any of these implementations of special purpose computing or logic circuits for inputting and processing input data according to a control algorithm and providing output control signals.

FIG. 1 illustrates an accessory microcontroller 16 physically mounted to and transportable with the vehicle. A data interface 18 connects a data bus 20 to a conventional microcontroller 22 so that the accessory microcontroller 16 can communicate bi-directionally with the vehicle's data bus 12. Additionally, discrete logic circuitry 24 is connected to the microcontroller 22 but is shown in phantom because the discrete logic is optional. Although all the inputs to the accessory microcontroller 16 can be applied to a conventional microcontroller, it is often preferred that some or all of the inputs from the accessory input devices be applied to separate logic circuits in many cases because this improves the reliability of those input signals.

The accessory microcontroller 16 is connected to one or more accessory input devices 26 and to one or more accessory output devices 28. Although it is not always necessary to have both accessory inputs and accessory outputs, having both is necessary or preferred in many embodiments of the invention. The accessory input devices 26 provide information or data that is sensed or detected from the accessory or manually input in association with operation of the accessory. Typical accessory inputs include inputs from state or limit switches that detect the presence or absence of a structure at a particular position in an accessory, voltage inputs signaling whether a circuit element is actuated, analog inputs signaling the magnitude of an accessory parameter such as a linear displacement detector or strain gauge or an air or hydraulic pressure sensor, and digital data inputs, such as from an angular position sensor or digital sensor versions of the above analog sensors. For example, an input may be from a connection to the lift door switch of a wheel chair lift. Input devices can also be manually actuated devices such as control switches or DIP switches for selecting an operational mode or characteristics. The output devices 28 perform some action upon or associated with the accessory. Typical accessory output devices include closed loop mechanical structure position controllers, switches for interrupting the operation of a component of an accessory such as a hydraulic pump, auxiliary switches for use by an accessory installer, signaling devices and data processing equipment. Thus, output devices can be analog, digital or simply on/off switches, such as a relay controlling an accessory operation or parameter. For example, the output devices can be a lock mechanism for locking a shifter to prevent a change in gear position or a parking brake lock to prevent release of the parking brake.

Any of the data links can be a wireless data link using available wireless data technology. The preferred wireless data link for some applications is the data bus 20 and is accomplished by connecting one transceiver to the accessory control connector 14 and the other transceiver to the accessory microcontroller 16. By making the data bus 20 a wireless link, the accessory microcontroller 16 can be located remotely from the OBD connector 10, such as on or in an accessory, without requiring a hardwire connection from the accessory control connector 14. The wireless data links can include not only data buses, but also can include a wireless data link to or from one or more accessory inputs 26 or outputs 28.

Data for hundreds of vehicle parameters are available at the OBD connector 10. These data include engine rpm, engine timing, oil pressure, water temperature, the gear shift position, whether the service brake is depressed, whether the emergency brake is engaged, vehicle speed, battery voltages and hundreds of other vehicle data. Although dependent upon the applicable protocol, data is typically transmitted from the OBD connector serially in a sequence of packets. Some data is repeatedly transmitted in a particular sequence while other data requires an interrogation of the vehicle's on board computer. Whatever the protocol, the OBD connector presents a two way data bus so the vehicle's on board computer may also be interrogated by commands transmitted in accordance with the protocol and the requested data is then output on the data bus 12. Therefore it is possible to not only receive the particular data that is normally transmitted, but data for other parameters may be transmitted following interrogation.

In addition, data can also be input to the vehicle's on board computer in accordance with the protocol so that some control of vehicle parameters is also possible through inputs to the OBD connector or its data bus. For example, the on board computer can be instructed to operate the engine at a selected rpm parameter. This allows the invention to control engine speed and also to stop the engine by instructing the on board computer to operate the engine at zero rpm or at some other rpm at which the engine is incapable of operating, such as 10 rpm, so the engine therefore stops.

There are many specific implementations of the invention a few of which are described below. Features of these implementations, or entire implementations, can be combined in other implementations. Particularly valuable for many implementations are the features for maintaining the vehicle in a “safe” condition when the vehicle is stationery and an accessory is being operated. Such an implementation can not only make sure the vehicle is in a safe condition before it permits operation of the accessory to commence, but can prevent an unsafe operation from changing the vehicle into an unsafe condition. The accessory microcontroller 16 continuously monitors both vehicle and accessory parameters. Some of those parameters are common and critically important to multiple implementations. These include whether the parking brake is applied, the gear shift control status, the engine rpm and whether the service brake is applied. Because the accessory microcontroller continuously monitors the parameters, it can determine whether any of these parameters changes and then take remedial controlling action. For example, service brake depression is a precursor to other vehicle operations, such as putting the vehicle in gear. Similarly, the clutch for a manual transmission is a precursor for the same action. Thus, upon sensing that one of these precursor actions has occurred, the accessory microcontroller 16 can take an action, such as stopping the engine.

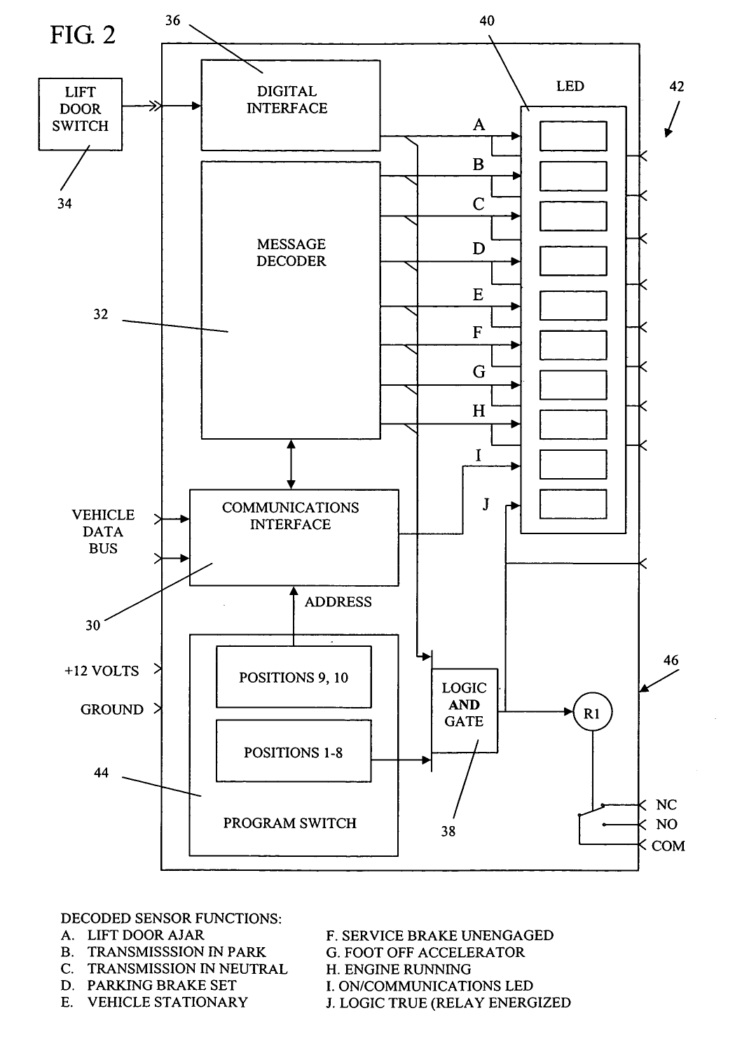

WHEELCHAIR LIFT CONTROL. FIG. 2 illustrates an implementation embodying the invention for use with the accessories of vehicles such as utility trucks, ambulances, fire trucks and police vehicles all of which commonly have accessories mounted to the vehicle. However, as an example, it is described in connection with a wheelchair lift.

The embodiment of FIG. 2 has a communications interface 30 in data communication with a logic device identified as a message decoder 32. A lift door switch 34 on the wheelchair lift accessory provides an accessory input to a digital interface 36 to signal when the wheel chair lift door is opened, i.e. ajar. The digital data output of the digital interface 36 and the outputs of the message decoder 32 apply their output data to a logic AND gate 38 as well as to a series of LED display signals 40 and to a series of conductors of another connector to provide auxiliary outputs 42 for use in actuating remote LED displays or for further data processing. A program switch 44, such as a DIP switch with 10 switches, allows programming. The embodiment of FIG. 2 permits monitoring and signaling of eight vehicle parameters identified as A through H on FIG. 2. Each available parameter corresponds to a different one of the eight switches at switch positions 1-8 so the desired parameters are selected by manually actuating the switches corresponding to the desired parameters. Since some accessories require monitoring of fewer than all parameters, the DIP switch allows only the required parameters to be selected. For example, some applications require that both the parking brake be engaged and the transmission be in neutral while others require only that the parking brake be engaged. An additional two of the program switches 44, at positions 9 and 10, permit selection of any one of four addresses for the FIG. 2 embodiment. This allows up to four such embodiments to be used simultaneously on a single vehicle, each with a different address, for example for four different accessories. The AND gate 38 provides a logical AND operation of all those parameters A-H which were selected by the DIP switches. Therefore, when all the selected parameters are in the active or TRUE state, the relay R1 is actuated and closes the normally open switch NO and opens the normally closed switch NC. For example, the TRUE state for each parameter may represent the required state for permitting accessory operation. Therefore, when all parameters that are selected by the DIP switches are true, the relay R1 is actuated to signal the existence of a safe condition and permit accessory operation. If a vehicle lacks a sensor for a parameter, such as the parking brake, other parameters may be substituted, such as the vehicle stationary parameter. The provision of both a normally open switch NO and a normally closed switch NC allows this embodiment to be used for both those wheel chair interlock inputs which require a connection to ground for signaling a safe condition and those that require the application of 12v.

From the above it is apparent that the logical, data processing functions the embodiment of FIG. 2 are distributed between the message decoder 32 and the logic gate 38 so that they, together with the digital interface 36 and the communications interface 30 form the accessory microcontroller of this embodiment.

ALTERNATIVE ENGINE KILL. Some vehicle manufacturers provide a separate, dedicated engine kill connection. For example, a pin connection to the engine control module, known on some models as “PTO Engine Kill” is dedicated to the engine kill function and stops engine operation, for example whenever the pin is connected to vehicle ground. One of the outputs illustrated in FIG. 1 may be connected to this pin for outputting an engine kill control signal from the accessory microcontroller. As a more specific example, the relay R1 of FIG. 2 is provided with normally open switch contacts NO which can be connection to the dedicated kill pin to ground it in the event sensed parameters reveal the occurrence of an unsafe event.

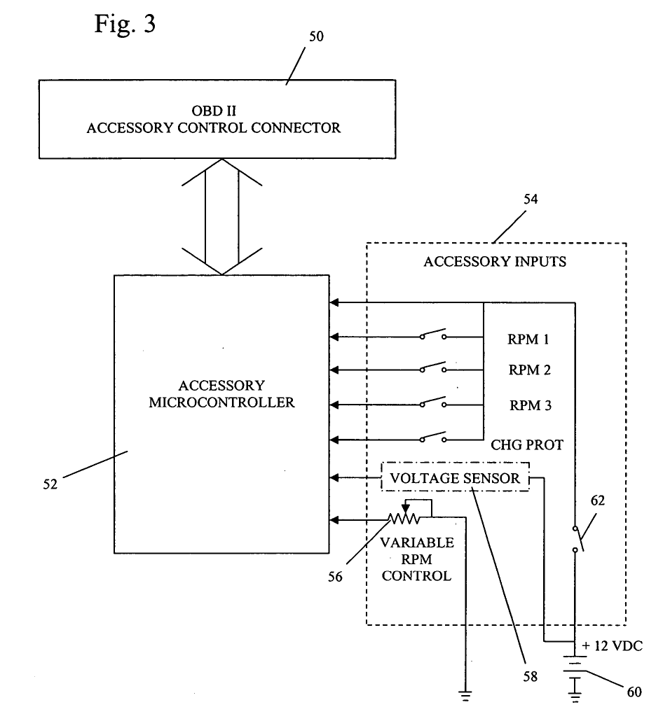

RPM CONTROL. FIG. 3 illustrates an implementation embodying the invention for use in controlling the engine rpm for multiple purposes. Such an accessory has one or more input devices that each provide an input to the accessory control logic system or microcontroller from which the control logic can generate a control signal to control some vehicle parameter. Like the embodiment of FIG. 1, the embodiment of FIG. 3 has an accessory control connector 50 which is connected to the vehicle's on board data bus in order to connect that data bus to the accessory microcontroller 52. Multiple accessory inputs 54 apply their data inputs to the accessory microcontroller 52. The accessory inputs include four input switches labeled RPM 1, RPM 2, RPM 3 and CHG PROT. The input switches RPM 1, RPM 2, and RPM 3 are switches on the accessory, such as an air compressor or hydraulic pump. For example, each switch can be connected to an air pressure sensor so that engine speed is a function of air tank pressure. RPM 1 may be connected to a switch which closes when the air tank pressure declines to a selected lower pressure and this switch closure can then increase the engine speed. The switch RPM 2 may be connected to a pressure switch which closes when the tank reaches a selected maximum pressure to cause the engine speed to be reduced. Upon sensing of a high pressure the accessory microcontroller 52 drives the engine at the selected lowest speed, sensing a very low pressure drives the engine at a selected high speed. The third switch can be used to detect a pressure within an intermediate range to drive the engine at an intermediate speed. Switching of any one of these three switches selects any one of three preprogrammed engine speeds. Each of these three switches are preprogrammed to an engine speed in a conventional manner including in software, by logic or by adjustable potentiometers. The accessory microcontroller then sends the command to the vehicle's on board computer for the selected engine speed when the accessory is activated. Of course only two switches could be used for controlling engine speed between selected high and low engine speeds. Preferably, the accessory microcontroller is programmed to provide a priority for each of these switches so that, in the event of the activation of more than one switch, the microcontroller acts upon the input from the one with the highest priority.

A variable rpm control 56 is an accessory input device that provides the ability for user selection and adjustment of an engine speed continuously over a range of engine speeds. The variable rpm control is a potentiometer. The potentiometer 56 can be either mechanically connected to some accessory component or manually actuable to provide an analog control signal level as an accessory input to control engine rpm. For example, a remote accelerator pedal or hand operated lever can be mechanically linked to a potentiometer and used for control of engine speed.

The accessory microcontroller 52 may be programmed not only to output control commands for controlling the engine speed as a function of the inputs 54, but can also be programmed to control the rate of change of the engine speed as it is varied from one engine speed to another. This is desirable for accessories that could be damaged by an excessive acceleration or deceleration of engine speed.

It should be apparent that the invention is not limited to the illustrated inputs but can include more or fewer such inputs.

CHARGE PROTECTION. The embodiment of FIG. 3 has an optional battery charge protection feature which can also be implemented on numerous other embodiments. A vehicle battery voltage sensor 58 has its input connected to the vehicle's storage battery 60 and its output connected to the accessory microcontroller 52. Preferably, the voltage sensor 58 both senses the battery voltage and has an A/D converter to provide a digital output. When the charge protect switch CHG PROT is switched to activate the charge protect mode, the battery voltage parameter is applied to the accessory microcontroller 52. The accessory microcontroller 52 then transmits an engine rpm command to the vehicles on board computer in accordance with the charge protection algorithm programmed into the accessory microcontroller to adjust the engine speed to a value which supplies sufficient electrical power to vehicle and/or accessory electrical loads and maintains the battery in a charged condition.

Operation of the accessory microcontroller 52 is activated by a switch 62. This switch 62 can be a manually actuable by the vehicle operator. Alternatively, it can be a switch mounted to an accessory for activating the control features, for example when an accessory is actuated or is sensed to go to a selected state. As another alternative, the switch 62 can be the vehicle ignition switch so that the accessory microcontroller is automatically activated when the vehicle is operated.

From the above examples of embodiments of the invention, it can be seen that the accessory microcontroller can be programmed to interrogate the on board computer for battery voltage data and monitor the battery voltage. The accessory microcontroller can similarly monitor the safety-related parameters of both the vehicle and the accessory, the engine speed and/or many other inputs from the accessory and the on board computer. The accessory microcontroller can process this data and then apply data instructions through the OBD connector or the vehicle's data bus to the vehicle on board computer to cause the vehicle to go to the desired vehicle parameters, such as engine rpm. The accessory microcontroller can increase engine speed in accordance with a selected algorithm, such as a closed loop negative feedback control algorithm for maintaining an engine speed which maintains a selected battery voltage. Alternatively, battery related data may be provided to an accessory so that the accessory controls engine speed as a function of battery voltage. This is particularly useful on vehicles with dual voltage systems or remote batteries. The accessory microcontroller can also shut down engine operation if it detects an unsafe condition.

SAFETY INTERLOCK. An accessory may be provided with an input device or sensor that, for example, has a state indicating that the accessory in being operated. For example, a switch may be actuated when a wheelchair lift, a crane or a hydraulically operated support leg is being deployed or operated. It is desirable that operation of the accessory not begin unless the vehicle is in a safe condition and to maintain that safe condition during operation of the accessory. For example, referring again to FIG. 2, the lift door switch 34 input is connected to the accessory microcontroller which maintains the vehicle in a safe condition during wheel chair lift operation. An output device, such as a relay switch 46 that can interrupt electrical power to the accessory, may be connected to the accessory microcontroller so that the accessory microcontroller can monitor the vehicle condition and prevent accessory operation until the vehicle is in a safe condition. Thus, the relay switch 46 can be switched to apply power to the lift and permit its operation after the vehicle computer is interrogated and the safety related parameters are found to be in a safe mode. Of course, the output device can alternatively be, or include, a warning signal, such as an audible signal and/or a light to signal to the operator, either to warn against deployment or to signal that deployment may be initiated.

Importantly, there is also the possibility that, during operation of an accessory, such as during deployment of a wheelchair lift or when a power take off is engaged to drive some machinery, a person may shift the vehicle into a running gear, disengage the parking brake or depress the service brake. Because embodiments of the invention can monitor the vehicle parameters and therefore detect such a potentially unsafe action, the accessory microcontroller can initiate an action to prevent an injury or damage. For example, the accessory microcontroller can immediately stop the engine operation by signaling the on board computer to switch the engine speed to zero rpm or any other low speed at which the engine can not operate. The desirably monitored vehicle parameters include the parameters listed in FIG. 2.

VEHICLE SURVEILLANCE AND SECURITY. Another feature that can be programmed into the accessory microcontroller of the invention is to monitor vehicle operation for inactivity. For example, a person may deploy the wheelchair lift, depart from the vehicle, retract the lift and close all doors, but leave the vehicle with the engine running. In fact, people often leave vehicles with the engine running even in the absence of an accessory. Thus, the microcontroller can be programmed to monitor vehicle parameters, such as engine speed, gear shift location and/or brake pedal operation. If there is a lack of activity for some selected period of time, that is there is no appreciable variation in the monitored parameter(s), the accessory microcontroller can take a defensive action, for example stop the engine in the manner described above after a ten minute interval of inactivity.

DATA SUPPLY. The manufacturers of some accessories may not have a need to control any of the vehicle parameters but may still have a need to input vehicle parameter data to their accessory for controlling it. A monitoring device can be provided in accordance with the invention which allows a manufacturer to select the data the manufacturer wants by actuating selected DIP switches, or other input devices, on the monitoring device. The monitoring device includes its own controller provided with software so that it reads the DIP switches, monitors the selected parameters and provides the requested data on an output connector. In a more simplified form, the monitoring device can provide one or more simple switch outputs for connection to a component of the accessory. As will be understood by those skilled in the art, even simple, two-state switches are viewed as data links. The accessory microcontroller switches the switch to one state when the monitored parameter exceeds a selected value, is less than a selected value or is within a range of values. Such a monitoring device can, of course, also provide one or multiple data outputs or analog outputs to the accessory for controlling one or more components of the accessory.

For example, if an operator of a fleet of vehicles has found that parking brakes seem to wear prematurely because the drivers forget to disengage them when driving, a monitoring device accessory can illuminate a bright red light or other signal to warn the driver that the parking brake is on. A device of this nature can be compact and is connected to the OBD connector which is advantageously located below the vehicle dashboard where its signals may easily be observed by the driver. In a similar manner, the driver can be warned that the vehicle is in gear, the water temperature is too high or the oil pressure is too low. For these and other vehicle parameters, a switched output or parameter data may be provided for use by another accessory or signal which may be remote from the driver. Furthermore, the monitoring accessory can be programmed to stop the engine under certain conditions, such as a low oil pressure.

REMOTE INFORMATION DISPLAY AND CONTROL. Another implementation of a monitoring accessory is a remote instrument or data panel at which it is desired to display particular vehicle parameters, such as rpm, oil pressure or battery charging or condition. Remote panels are ordinarily very difficult to install in accordance with the prior art because they require hard wiring into the vehicle at the remote locations of the sensors, as described above. The invention allows all the data to be generated from the OBD connector bus by an accessory which connects to the OBD connector bus and has its own accessory microcontroller for obtaining the requested vehicle parameter data and transmitting it by a data link to a remote display.

Not only may data be displayed at a remote location on the vehicle, but remote control of the accessory, and interdependent control of the vehicle and accessory parameters can be maintained from a remote location on the vehicle. Although this can be done by a hard wire connection to the data bus of the on board diagnostic port connector, existing wireless data links can be advantageously used to establish the data communication.

SELF DIAGNOSTICS. Vehicles have many switches for signaling a state of some vehicle component. One is the park brake switch. Because the park brake is mechanical device, its calibration changes over time as a result of wear or alternatively, the park brake may become frozen and inoperable from non-use for a long period of time. An embodiment of the invention can be programmed to force the operator to periodically test the park brake. Such a test may require the operator, at selected time or vehicle usage intervals, to test the park brake by actuating the park brake, put the vehicle in gear, increase engine speed to a selected rpm to assure that the brake holds the vehicle in place rather than creeping. So the accessory microcontroller may, for example, initiate a self diagnostic routine every 50^{th} time a vehicle is operated by giving the driver an audible or visible signal that the test must be performed. Normal vehicle operation may be prevented, for example by limiting engine speed, until the test is completed. Because the vehicle's on board computer system can detect the condition of the park brake, the gear shift lever and engine rpm, and that data is available to a self diagnostic accessory connected to the data bus, the microcontroller of the self diagnostic accessory can detect whether the test has been completed and can in fact control part of it, such as the engine speed during the test. Other tests can be similarly programmed into the accessory microcontroller.

While certain preferred embodiments of the present invention have been disclosed in detail, it is to be understood that various modifications may be adopted without departing from the spirit of the invention or scope of the following claims.

1. A control apparatus for an accessory mounted to a vehicle, the vehicle having an on board diagnostic port connector connected through a data bus to the vehicle's on board engine control computer, the apparatus comprising:
(a) an accessory control connector for connecting to the vehicle's on board diagnostic port data bus;
(b) an accessory microcontroller physically mounted to and transportable with the vehicle and connected through a data communication path with the accessory control connector; and
(c) at least one device associated with a component of the accessory and connected through a data communication path with the microcontroller, the device being at least one of
(i) an accessory input device for sensing an accessory parameter and transmitting the sensed parameter data to the microcontroller or
(ii) an accessory output device operating a component of the accessory for control of an accessory parameter by the microcontroller.

2. An apparatus in accordance with claim 1 wherein at least one of the data communication paths is a wireless data connection.

3. An apparatus in accordance with claim 1 wherein the accessory comprises a wheelchair lift, and wherein there are both an accessory input device and an accessory output device, the accessory input device comprising a wheelchair lift door switch and the accessory output device comprising a prime mover for operating the wheelchair lift.

4. An apparatus in accordance with claim 1 wherein the accessory microcontroller is programmed to input data from the diagnostic port data bus consisting of at least one input parameter selected from the group consisting of parking brake status, a gear shift control status, engine rpm, clutch status, vehicle speed and service brake status.

5. An apparatus in accordance with claim 1 and having at least an accessory input device, and wherein the microcontroller is programmed to stop the engine by transmitting data to the vehicle's on board engine control computer in response to a selected change in an accessory input parameter transmitted to the microcontroller from the accessory input device.

6. An apparatus in accordance with claim 1 and further comprising an LED dr other visual display connected to an output of the accessory microcontroller for signaling a state of a vehicle parameter received from the vehicle's data bus.

7. An apparatus in accordance with claim 1 and having at least an accessory input device comprising a plurality of switches connected to the accessory for sensing an accessory parameter and transmitting the sensed parameter data to the microcontroller, the microcontroller being programmed to send a different engine speed control command to the vehicle's computer for each switch, each command corresponding to a different engine speed.

8. An apparatus in accordance with claim 1 and further comprising an accessory input device comprising at least one switch connected to an input of the accessory microcontroller, the accessory microcontroller being programmed to transmit an instruction to the vehicle's engine control computer for driving the engine speed to a selected engine speed in response to actuation of the switch.

9. An apparatus in accordance with claim 1 and further comprising an accessory input device comprising at least an accessory parameter sensor for sensing an accessory parameter continuously over a selected range, the input device being connected to the accessory microcontroller for providing a continuously variable input to the accessory microcontroller and wherein the accessory microcontroller is programmed to read vehicle parameter data from the data bus and to communicate vehicle parameter control data to the vehicle's on board engine control computer for controlling the speed of an engine of the vehicle as a function of the value of the continuously variable input.

10. An apparatus in accordance with claim 9 wherein the input device comprises a voltage sensor for inputting a signal representing a voltage.

11. An apparatus in accordance with claim 9 wherein the input device comprises a pressure sensor for inputting a signal representing a voltage.

12. A method for controlling parameters of a vehicle having an accessory mounted to the vehicle, the vehicle having a vehicle control computer connected to an on board diagnostic port connector through a data bus, the accessory having at least one data input device for supplying data representing a parameter of the accessory, the method comprising:
(a) attaching an accessory control connector to the data bus;
(b) inputting data from both the data bus and the vehicle accessory to an accessory microcontroller; and
(c) outputting a control signal from the accessory microcontroller in accordance with a microcontroller control algorithm.

13. A method in accordance with claim 12 wherein the control signal is output to at least the vehicle's control computer in response to the input data for controlling a vehicle parameter.

14. A method in accordance with claim 12 wherein the accessory includes at least one output device for operating the accessory, and the method further comprises outputting the control signal to the accessory output device.

15. A method in accordance with claim 12 or 13 or 14 wherein the data input from the diagnostic port data bus consists of at least one input parameter selected from the group consisting of parking brake status, a gear shift control status, engine rpm, clutch status, vehicle speed and service brake status.

16. A method in accordance with claim 12 or 13 or 14 wherein the step of outputting a control signal comprises transmitting a command to the vehicle computer to stop engine operation.

17. A method in accordance with claim 16 wherein the data input from the diagnostic port data bus consists of at least one input parameter selected from the group consisting of parking brake status, gear shift control status, engine rpm, clutch status, vehicle speed and service brake status.

18. A method in accordance with claim 17 wherein the command to stop engine operation comprises transmitting a command to operate the engine at an rpm parameter value at which the engine stops.

19. A method in accordance with claim 18 wherein the command to stop engine operation comprises transmitting a command to operate the engine at zero rpm.

20. A method in accordance with claim 12 and further comprising outputting an engine kill control signal to a separate, dedicated engine kill connection.
